(19) United States
(12) Patent Application Publication
(10) Pub. No.: US 2009/0232076 A1
(43) Pub. Date: Sep. 17, 2009

(54) Method and Apparatus for Handling a Contention-Based Random Access Procedure

(76) Inventor: Richard Lee-Chee Kuo, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/403,347

(22) Filed: Mar. 12, 2009

Related U.S. Application Data
(60) Provisional application No. 61/036,478, filed on Mar. 14, 2008.

(51) Int. Cl. H04W 72/12

(52) U.S. Cl. 370/329

(57) ABSTRACT

A method for handling a contention-based random access procedure in a user equipment (UE) of a wireless communication system is disclosed. The method includes steps of sending a Scheduled Transmission message, which applies an HARQ (Hybrid Automatic Repeat request) process for transmission, starting a Contention Resolution Timer and monitoring a PDCCH (Physical Downlink Control Channel), and flushing a buffer of the HARQ process used for transmission of the Scheduled Transmission message when a contention result of the random access procedure is determined.

### CROSS REFERENCE TO RELATED APPLICATIONS

This application claims the benefit of U.S. Provisional Application No. 61/036,478, filed on Mar. 14, 2008 and entitled “Method and Apparatus for Flushing HARQ Buffer during a Random Access Procedure in a Wireless Communication System”, the contents of which are incorporated herein by reference.

### BACKGROUND OF THE INVENTION

1. Field of the Invention

The present invention relates to a method and apparatus for handling a contention-based random access procedure, and more particularly, to a method and apparatus for handling a contention-based random access procedure in a wireless communication system to appropriately terminate retransmission of a Scheduled Transmission message.

2. Description of the Prior Art

Long Term Evolution wireless communication system (LTE system), an advanced high-speed wireless communication system established upon the 3G mobile telecommunication system, supports only packet-switched transmission, and tends to implement both Medium Access Control (MAC) layer and Radio Link Control (RLC) layer in one single communication site, such as in Node B (NB) alone rather than in NB and RNC (Radio Network Controller) respectively, so that the system structure becomes simple.

In LTE system, a user equipment (UE) needs to initiate a random access procedure to establish contact with NB for any of the following events: (1) Initial access from a RRC_IDLE state; (2) Initial access after a radio link failure; (3) Handover requiring random access procedure; (4) Downlink data arrival during a RRC_CONNECTED state requiring random access procedure; (5) Uplink data arrival during RRC_CONNECTED requiring random access procedure. Besides, the random access procedure can be performed by contention-based or non-contention-based manner depending on whether a Random Access Channel (RACH) resource used by the UE is assigned by the network or randomly selected by the UE itself.

Please refer to FIG. 1, which is a schematic diagram of a contention-based random access procedure. As shown in FIG. 1, the contention-based random access procedure mainly includes the following four steps: (1) Step “Random Access Preamble on RACH in uplink”, (2) Step “Random Access Response on Downlink Share Channel (DL-SCH)”, (3) Step “Scheduled Transmission on Uplink Share Channel (UL-SCH)”, (4) Step “Contention Resolution on DL-SCH or Physical Downlink Control Channel (PDCCH)”. When a random access procedure is triggered by the RRC layer or the MAC layer, the UE firstly transmits a Random Access Preamble to NB by using a randomly selected RACH resource. After receiving a valid Random Access Response message from the NB, the UE shall send a Scheduled Transmission message with UE identity information to the NB. Then, contention can be resolved when the UE receives a Contention Resolution message containing specific UE identity information from the NB. Detailed operation of the random access procedure is referable in related MAC specification, and is not narrated herein.

According to different trigger events, the above UE identity information can be a Cell Radio Network Temporary Identifier (C-RNTI) MAC control element or a UE Contention Resolution Identity included in a Common Control Channel (CCCH) message and provided by an upper layer. In the prior art, once the Scheduled Transmission message with the UE identity information is transmitted, e.g. an uplink message containing a C-RNTI MAC control element is transmitted or an uplink message containing a CCCH message is transmitted, the UE shall start a Contention Resolution Timer and monitor the PDCCH for reception of the Contention Resolution message until the Contention Resolution Timer expires.

For the case of the uplink message containing a C-RNTI MAC control element, the UE shall consider the Contention Resolution as successful if receiving a PDCCH transmission addressed to its C-RNTI. And for the case of the uplink message containing a CCCH message, the UE shall consider the Contention Resolution as successful if a received MAC Packet Data Unit (PDU) contains a UE Contention Resolution Identity MAC control element which matches the UE Contention Resolution Identity provided by the upper layer. Otherwise, the UE shall consider the Contention Resolution as not successful. Besides, for both cases the UE shall also consider the Contention Resolution as not successful when the Contention Resolution Timer expires.

On the other hand, a Hybrid Automatic Repeat request (HARQ) process is applied for transmission of the Scheduled Transmission message. Thus, according to the current specification, the UE starts monitoring the PDCCH before receiving any HARQ feedback associated with the Scheduled Transmission message from the NB. It can take care of ACK to NACK error so that the contention can be resolved as soon as possible.

Therefore, if the ACK to NACK error occurs, the associated HARQ process will still continue the retransmission of the Scheduled Transmission message. However, once the UE receives the Contention Resolution message from the NB, it implies that the NB has received the Scheduled Transmission message. So, there is no need for the UE to continue retransmitting the Scheduled Transmission message. In such a situation, since the NB may have allocated uplink resources that the UE originally used to transmit the Scheduled Transmission message to other UE, continuing the retransmission of the Scheduled Transmission message may interfere uplink transmission of other UE. Besides, continuing the retransmission of the Scheduled Transmission message also causes unnecessary power consumption of the UE.

### SUMMARY OF THE INVENTION

It is therefore an objective of the present invention to provide a method and apparatus for handling a contention-based random access procedure in a user equipment (UE) of a wireless communications system, so as to appropriately terminate retransmission of a Scheduled Transmission message for preventing uplink transmission of other UE from being interfered.

According to the present invention, a method for handling a contention-based random access procedure in a user equipment (UE) of a wireless communication system is disclosed. The method includes steps of sending a Scheduled Transmission message, the Scheduled Transmission message applying a Hybrid Automatic Repeat reQuest (HARQ) process for transmission; starting a Contention Resolution Timer and monitoring a Physical Downlink Control Channel (PDCCH); and flushing a buffer of the HARQ process used for transmission of the Scheduled Transmission message when a contention result of the random access procedure is determined.

According to the present invention, a communications device for handling a contention-based random access procedure in a user equipment (UE) of a wireless communication system is disclosed. The communications device includes a processor for executing a program code, and a memory, coupled to the processor, for storing the program code. The program code includes steps of sending a Scheduled Transmission message, the Scheduled Transmission message applying a Hybrid Automatic Repeat reQuest (HARQ) process for transmission; starting a Contention Resolution Timer and monitoring a Physical Downlink Control Channel (PDCCH); and flushing a buffer of the HARQ process used for transmission of the Scheduled Transmission message when a contention result of the random access procedure is determined.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a contention-based random access procedure.

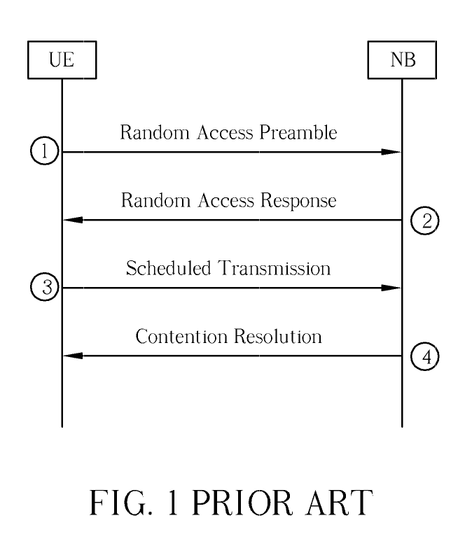

FIG. 2 is a schematic diagram of a wireless communications system.

FIG. 3 is a function block diagram of a wireless communications device.

FIG. 4 is a diagram of program code of FIG. 3.

FIG. 5 is a flowchart of a process according to an embodiment of the present invention.

### DETAILED DESCRIPTION

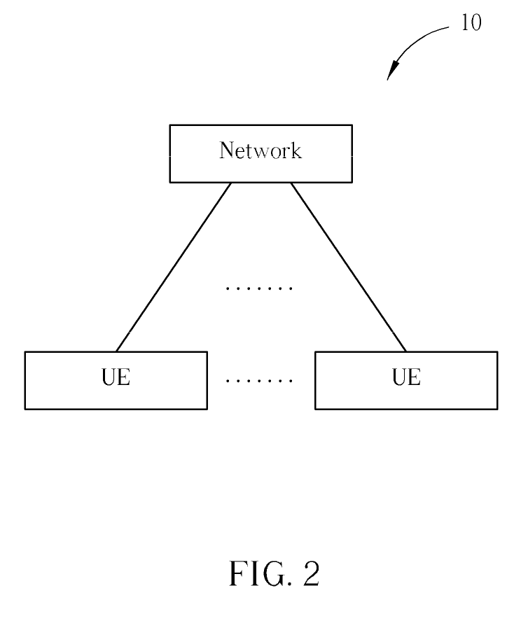

Please refer to FIG. 2, which illustrates a schematic diagram of a wireless communication system 10. The wireless communication system 10 is preferably an LTE (long-term evolution) system, and is briefly composed of a network and a plurality of UEs. In FIG. 2, the network and the UEs are simply utilized for illustrating the structure of the wireless communication system 10. Practically, the network may comprise a plurality of base stations (Node Bs), radio network controllers and so on according to actual demands, and the UEs can be devices such as mobile phones, computer systems, etc.

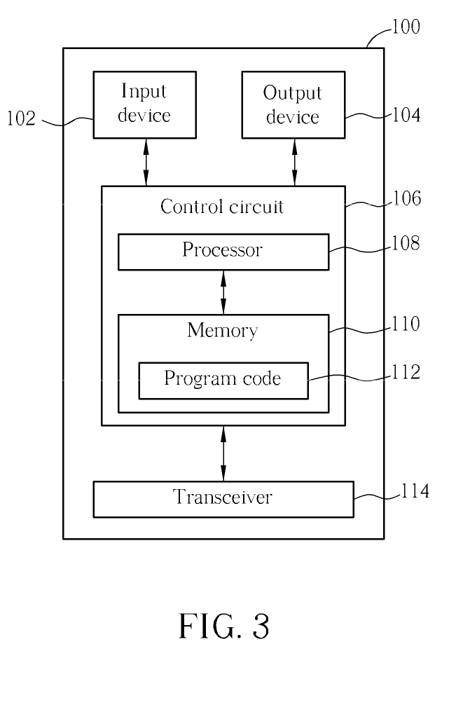

Please refer to FIG. 3, which is a functional block diagram of a communication device 100 in a wireless communication system. The communications device 100 can be utilized for realizing the UEs in FIG. 2. And the wireless communications system is preferably the LTE system. For the sake of brevity, FIG. 3 only shows an input device 102, an output device 104, a control circuit 106, a central processing unit (CPU) 108, a memory 110, a program code 112, and a transceiver 114 of the communication device 100. In the communication device 100, the control circuit 106 executes the program code 112 in the memory 110 through the CPU 108, thereby controlling an operation of the communication device 100. The communication device 100 can receive signals input by a user through the input device 102, such as a keyboard, and can output images and sounds through the output device 104, such as a monitor or speakers. The transceiver 114 is used to receive and transmit wireless signals, delivering received signals to the control circuit 106, and outputting signals generated by the control circuit 106 wirelessly. From a perspective of a communication protocol framework, the transceiver 114 can be seen as a portion of Layer 1, and the control circuit 106 can be utilized to realize functions of Layer 2 and Layer 3.

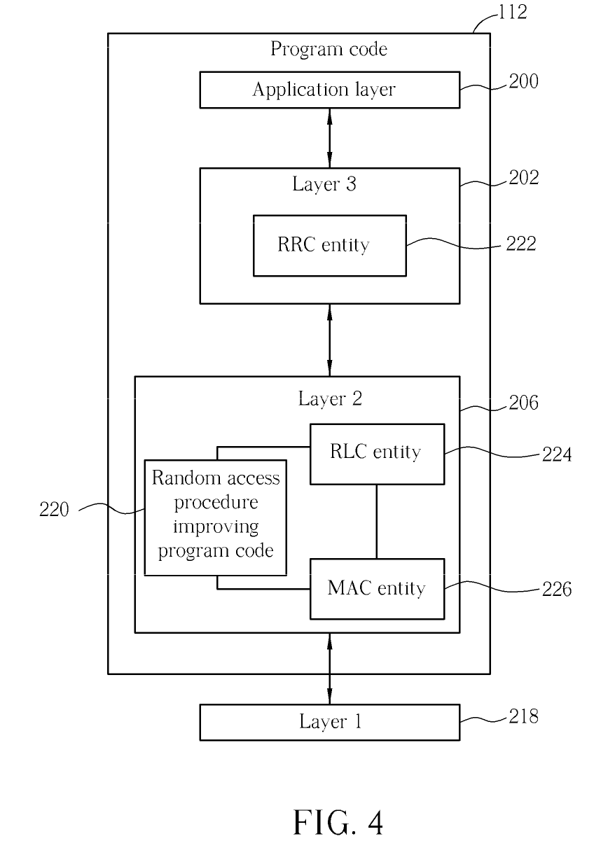

Please continue to refer to FIG. 4. FIG. 4 is a diagram of the program code 112 shown in FIG. 3. The program code 112 includes an application layer 200, a Layer 3 202, and a Layer 2 206, and is coupled to a Layer 1 218. The Layer 3 202 includes a radio resource control (RRC) entity 222 for exchanging RRC messages with other communications device, such as a NB or a radio access network, through RRC procedures and controlling the Layer 1 218 and the Layer 2 206 with the RRC messages and information elements (IEs) thereof. The Layer 2 206 includes a radio link control (RLC) entity 224 that is capable of operating in an Acknowledged Mode (AM), a Unacknowledged Mode (UM) and a Transparent Mode (TM) for delivering packets from upper layers. A medium access control (MAC) entity 224 that is a lower entity of the RLC entity 224 is used for initiating a random access procedure in some situation to establish contact with the NB

Moreover, the random access procedure can be performed by contention-based or non-contention-based manner depending on whether a Random Access Channel (RACH) resource used by the UE is assigned by the network or randomly selected by the UE itself. If a contention-based random access procedure is initiated, the UE shall send a Scheduled Transmission message carrying UE identity information to the NB for contention resolution. In such a situation, the embodiment of the present invention provides a random access procedure improving program code 220 in the program code 112 to avoid unnecessary retransmission of the Scheduled Transmission message, so as to prevent uplink transmission of other UE from being interfered and to prevent unnecessary power consumption of the UE.

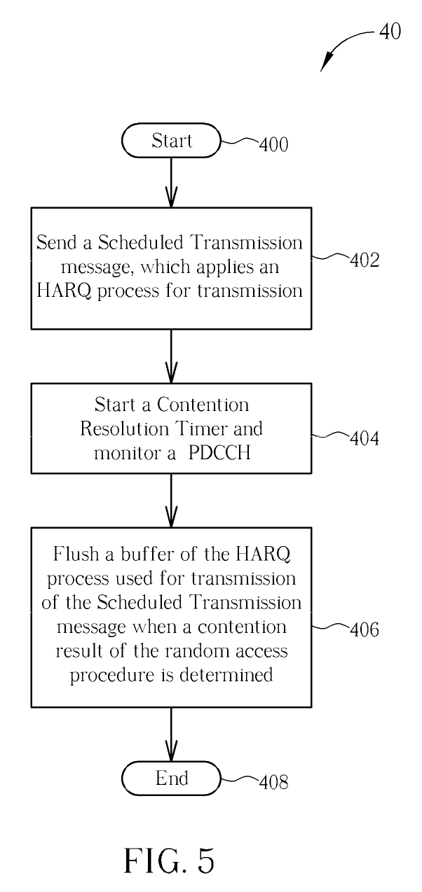

Please refer to FIG. 5, which illustrates a schematic diagram of a process 40. The process 40 is utilized for handling a contention-based random access procedure in a UE of the wireless communication system, and can be compiled into the random access procedure improving program code 220. The process 40 comprises the following steps:

Step 400: Start.

Step 402: Send a Scheduled Transmission message, which applies a Hybrid Automatic Repeat reQuest (HARQ) process for transmission.

Step 404: Start a Contention Resolution Timer and monitor a Physical Downlink Control Channel (PDCCH).

Step 406: Flush a buffer of the HARQ process used for transmission of the Scheduled Transmission message when a contention result of the random access procedure is determined.

Step 408: End.

According to the process 40, during the contention-based random access procedure, the UE sends the Scheduled Transmission message to the NB. The Scheduled Transmission message applies the HARQ process for transmission. Meanwhile, the UE starts the Contention Resolution Timer and monitor the PDCCH. When the contention result of the random access procedure is determined, the UE flushes the buffer of the HARQ process to terminate the retransmission of the Scheduled Transmission message.

Therefore, when the contention result of the random access procedure is determined, the UE flushes the HARQ process buffer associated with the Scheduled Transmission message, so as to terminate the retransmission of the Scheduled Transmission message. For example, if the contention result of the random access procedure is successful, it implies that the NB has correctly received the Scheduled Transmission message. So, there is no need for the UE to continue retransmitting the Scheduled Transmission message, and thereby the HARQ process buffer associated with the Scheduled Transmission message shall be flushed. Conversely, if the contention result of the random access procedure is unsuccessful, it implies that the UE shall repeat transmission of a Random Access Preamble. So, there is also no need for the UE to continue retransmitting the Scheduled Transmission message, and thereby the buffer of the associated HARQ process shall be flushed as well.

Consequently, when ACK to NACK error occurs in the HARQ process, the embodiment of the present invention can appropriately terminate the retransmission of the Scheduled Transmission message, so as to prevent uplink transmission of other UE from being interfered and to prevent unnecessary power consumption of the UE.

For the case of the Scheduled Transmission message including a Cell Radio Network Temporary Identifier (C-RNTI) MAC control element, the contention result of the random access procedure is determined to be successful when a PDCCH transmission addressed to a C-RNTI of the UE is received; otherwise, the contention result of the random access procedure is determined to be unsuccessful when the Contention Resolution Timer expires.

On the other hand, for the case of the Scheduled Transmission message including a Common Control Channel (CCCH) message and the CCCH message further containing an UE Contention Resolution Identity provided by an upper layer, the contention result of the random access procedure is determined to be successful when a MAC Packet Data Unit (PDU) received by the UE contains an UE Contention Resolution Identity MAC control element which matches the UE Contention Resolution Identity provided by the upper layer. Conversely, the contention result of the random access procedure is determined to be unsuccessful when a MAC PDU received by the UE contains an UE Contention Resolution Identity MAC control element which does not match the UE Contention Resolution Identity provided by the upper layer or when the Contention Resolution Timer expires.

In summary, when the contention result of the random access procedure is determined, the UE flushes the HARQ process buffer associated with the Scheduled Transmission message no matter the contention result is successful or not successful. As a result, the embodiment of the present invention can appropriately terminate the retransmission of the Scheduled Transmission message, so as to prevent uplink transmission of other UE from being interfered and to prevent unnecessary power consumption of the UE.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for handling a contention-based random access procedure in a user equipment (UE) of a wireless communication system, the method comprising:
sending a Scheduled Transmission message, the Scheduled Transmission message applying a Hybrid Automatic Repeat reQuest (HARQ) process for transmission;
starting a Contention Resolution Timer and monitoring a Physical Downlink Control Channel (PDCCH); and
flushing a buffer of the HARQ process used for transmission of the Scheduled Transmission message when a contention result of the random access procedure is determined.

2. The method of claim 1, wherein the contention result of the random access procedure is successful.

3. The method of claim 1, wherein the contention result of the random access procedure is unsuccessful.

4. The method of claim 1, wherein the Scheduled Transmission message comprises a Cell Radio Network Temporary Identifier (C-RNTI) Media Access Control (MAC) control element.

5. The method of claim 4, wherein the step of determining the contention result of the random access procedure comprises:
determining the contention result of the random access procedure to be successful when a PDCCH transmission addressed to a C-RNTI of the UE is received.

6. The method of claim 4, wherein the step of determining the contention result of the random access procedure comprises:
determining the contention result of the random access procedure to be unsuccessful when the Contention Resolution Timer expires.

7. The method of claim 1, wherein the Scheduled Transmission message comprises a Common Control Channel (CCCH) message, the CCCH message further comprising an UE Contention Resolution Identity provided by an upper layer.

8. The method of claim 7, wherein the step of determining the contention result of the random access procedure comprises:
determining the contention result of the random access procedure to be successful when a MAC Packet Data Unit (PDU) received by the UE contains an UE Contention Resolution Identity MAC control element which matches the UE Contention Resolution Identity provided by the upper layer.

9. The method of claim 7, wherein the step of determining the contention result of the random access procedure comprises:
determining the contention result of the random access procedure to be unsuccessful when a MAC Packet Data Unit (PDU) received by the UE contains an UE Contention Resolution Identity MAC control element which does not match the UE Contention Resolution Identity provided by the upper layer or when the Contention Resolution Timer expires.

10. A communication device for handling a contention-based random access procedure in a user equipment (UE) of a wireless communication system, the communication device comprising:
a processor for executing a program code; and
a memory, coupled to the processor, for storing the program code;
wherein the program code comprises:
sending a Scheduled Transmission message, the Scheduled Transmission message applying a Hybrid Automatic Repeat reQuest (HARQ) process for transmission;
starting a Contention Resolution Timer and monitoring a Physical Downlink Control Channel (PDCCH); and
flushing a buffer of the HARQ process used for transmission of the Scheduled Transmission message when a contention result of the random access procedure is determined.

11. The communication device of claim 10, wherein the contention result of the random access procedure is successful.

12. The communication device of claim 10, wherein the contention result of the random access procedure is unsuccessful.

13. The communication device of claim 10, wherein the Scheduled Transmission message comprises a Cell Radio Network Temporary Identifier (C-RNTI) Media Access Control (MAC) control element.

14. The communication device of claim 13, wherein the step of determining the contention result of the random access procedure comprises:
determining the contention result of the random access procedure to be successful when a PDCCH transmission addressed to a C-RNTI of the UE is received.

15. The communication device of claim 13, wherein the step of determining the contention result of the random access procedure comprises:
determining the contention result of the random access procedure to be unsuccessful when the Contention Resolution Timer expires.

16. The communication device of claim 10, wherein the Scheduled Transmission message comprises a Common Control Channel (CCCH) message, the CCCH further comprising an UE Contention Resolution Identity provided by an upper layer.

17. The communication device of claim 16, wherein the step of determining the contention result of the random access procedure comprises:
determining the contention result of the random access procedure to be successful when a MAC Packet Data Unit (PDU) received by the UE contains an UE Contention Resolution Identity MAC control element which matches the UE Contention Resolution Identity provided by the upper layer.

18. The communication device of claim 16, wherein the step of determining the contention result of the random access procedure comprises:
determining the contention result of the random access procedure to be unsuccessful when a MAC Packet Data Unit (PDU) received by the UE contains an UE Contention Resolution Identity MAC control element which does not match the UE Contention Resolution Identity provided by the upper layer or when the Contention Resolution Timer expires.
